(19) United States
(12) Patent Application Publication
(10) Pub. No.: US 2004/0187898 A1
(43) Pub. Date: Sep. 30, 2004

(54) Dishwasher

(76) Inventor: Chung-Ming Chen, Taipei (TW)

Correspondence Address: BACON & THOMAS, PLLC, 625 SLATERS LANE, FOURTH FLOOR, ALEXANDRIA, VA, 22314

(21) Appl. No.: 10/395,181

(22) Filed: Mar. 25, 2003

(51) Int. Cl. B08B 3/10

(52) U.S. Cl. 134/58 D; 134/105; 134/108; 134/172; 134/184; 134/200

(57) ABSTRACT

A dishwasher mainly includes a washing cabinet and a steam generator havingwater-feeding and steam-feeding holes provided at two ends thereof. Water fed into the steam generator via the water-feeding hole is quickly heated to produce high-temperature steam that is sent via the steam-feeding hole into a steam pipeline distributed over inner surfaces of the washing cabinet, so that the steam is sprayed via apertures and/or spray holes on the steam-feeding pipeline into the washing cabinet to sterilize and soften hardened food residues on the dishware positioned in the washing cabinet for washing, making the dishware effectively cleaned and sterilized.

### FIELD OF THE INVENTION

The present invention relates to a dishwasher having a washing cabinet and a steam generator. The steam generator has water-feeding and steam-feeding holes provided at two ends thereof. Water fed into the steam generator via the water-feeding hole is quickly heated to produce high-temperature steam that is sent via the steam-feeding hole into a steam pipeline distributed over inner surfaces of the washing cabinet, so that the steam is sprayed from the steam pipeline onto dishware positioned in the washing cabinet for washing.

### BACKGROUND OF THE INVENTION

Most of the conventional dishwashers are of flush type, in which water is circularly supplied to flush and thereby clean dishware positioned in the dishwasher. The dishware tends to have hardened food residues attached thereto if it is not positioned in water immediately after being used, causing difficulties in washing and cleaning the dishware with the dishwasher.

There are dishwashers using warmwater to wash dishware. Since it usually takes a considerable time to heat water and the warm water does not effectively soften the hardened food residues remained on the dishware, the dishware in the dishwasher could not be thoroughly cleaned in most cases. Moreover, the warm water does not provide the sterilization function. Therefore, conventional dishwashers do not provide sufficient cleaning and sanitary effects.

Taiwanese New Utility Model Patent Publication No. 309749 discloses a dishware washing system and arrangements thereof. The washing system includes a scrubbing unit and a washing and storing unit. The latter includes a housing in which a dishware washing space is defined, and a water tank consisting of a first and a second tank is provided. The first tank is provided with a water inlet, an air inlet, a heater, and a blower motor. The blower motor has an air outlet connected to a water-pumping mouth of the second tank and the water-pumping mouth is connected to a washing pipeline via a pumping motor. The washing pipeline is provided with spray nozzles to locate in the washing space. The pumping motor may pump heated water from the water tank, and the heated water is delivered via the washing pipeline to the spray nozzles to wash the dishware to be cleaned. Water may be added into the first tank and heated with the heater to produce steam for sterilizing the dishware to be cleaned. The steam produced by the heater also serves to dry the dishware. In the washing system disclosed in the above patent, the steam produced by the heater is used to sterilize and dry the dishware. However, in the whole washing process of the above patent, hardened food residues attached to the dishware could not be effectively removed to achieve a complete cleaning function.

It is therefore tried by the inventor to develop an improved dishwasher to eliminate drawbacks existed in the conventional dishwashers.

### SUMMARY OF THE INVENTION

A primary object of the present invention is to provide a dishwasher that not only washing but also sterilizing dishware to be cleaned.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a dishwasher according to a first embodiment of the present invention;

FIG. 2 is a schematic plan view showing a first washing manner of the dishwasher of FIG. 1;

FIG. 3 is a schematic plan view showing a second washing manner of the dishwasher of FIG. 1;

FIG. 4 is an exploded perspective view showing the mounting of rotatable sprinklers to the dishwasher of FIG. 1;

FIG. 5 is a schematic view showing the washing manner of the dishwasher of FIG. 1 with the rotatable sprinklers;

FIG. 6 shows the mounting of a feed-water heater in the dishwasher of FIG. 1;

FIG. 7 shows the mounting of a water pump in the dishwasher of FIG. 1;

FIG. 8 is a control circuit diagram for the dishwasher of FIG. 1;

FIG. 9 is an exploded perspective view of a dishwasher according to a second embodiment of the present invention;

FIG. 10 is a schematic plan view showing a first washing manner of the dishwasher of FIG. 9;

FIG. 11 is a schematic plan view showing a second washing manner of the dishwasher of FIG. 9;

FIG. 12 is an exploded perspective view showing the mounting of rotatable sprinklers to the dishwasher of FIG. 9;

FIG. 13 is a schematic view showing the washing manner of the dishwasher of FIG. 9 with the rotatable sprinklers;

FIG. 14 shows the mounting of a feed-water heater in the dishwasher of FIG. 9; and

FIG. 15 is a control circuit diagram for the dishwasher of FIG. 9.

### DETAILED DESCRIPTION OF THE PREFERRED EMBODIMENTS

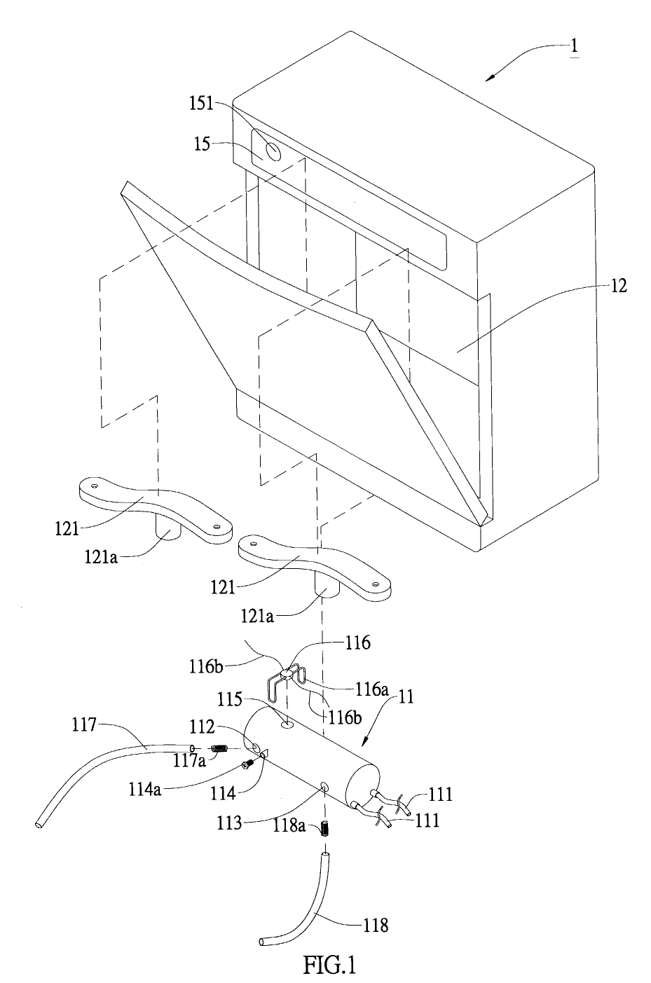

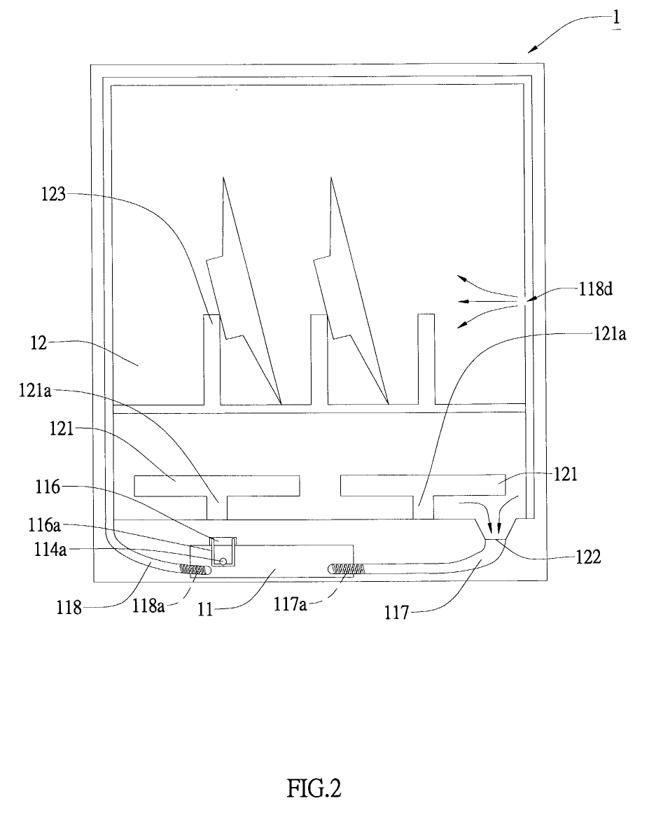

Please refer to FIGS. 1 and 2 in which a dishwasher 1 according to a first embodiment of the present invention is shown. As shown, the dishwasher 1 mainly includes a steam generator 11 and a washing cabinet 12 into which dishware to be washed are positioned.

The steam generator 11 has a power cord 111 connected to a lower side thereof, and is provided at two ends with a water-feeding hole 112 and a steam-feeding hole 113. Two threaded holes 114 are symmetrically provided at predetermined positions on an outer wall of the steam generator 11, and a temperature-sensing hole 115 is provided at a predetermined position near an upper side of the steam generator 11.

A temperature sensing and controlling unit 116 having a fixing bracket 116a extended from two opposite sides thereof and a power cord 116b connected thereto. is mounted above the temperature-sensing hole 115 of the steam generator 11 by locking two ends of the fixing bracket 116a to the threaded holes 114 with screw elements 114a, such that the temperature sensing and controlling unit 116 is firmly located on the steam generator 11 for sensing a temperature and controlling an operation of the steam generator 11.

Flushing blades 121 are rotatably connected at downward extended mounting stems 121a to an inner side of a bottom of the washing cabinet 12 to rotate while spray water upward to flush the dishware and remove any food residue therefrom. A water-collecting hole 122 is provided at a lower inner side of the washing cabinet 12. Washing is performed inside the washing cabinet 12 to clean all dishware positioned therein.

The steam generator 11 is mounted below the washing cabinet 12. A water-feeding hose 117 is connected to the water-feeding hole 112 to guide water into the steam generator 11. A steam-feeding pipeline 118 is connected to the steam-feeding hole 113 to distribute over inner surfaces of the washing cabinet 12. When the steam generator 11 starts operating, water fed thereinto is quickly heated and vaporized to produce high-temperature steam, which is sent via the steam-feeding hole 113 to the steam-feeding pipeline 118 and into the washing cabinet 12 via apertures 118d provided at predetermined points on the steam-feeding pipeline 118, and sprayed onto the dishware in the cabinet 12 to soften any hardened food residue attached thereto. Meanwhile, the flushing blades 121 rotate to spray water upward to washoff the softened food residues, so that an enhanced washing effect is provided. Moreover, the high-temperature steam provides a sterilization effect to thoroughly clean the dishware. When the steam generator 11 is overheated due to insufficient water feeding, the temperature sensing and controlling unit 116 is actuated to cut off the steam generator 11 to avoid the latter from being heated any further. Thus, the dishwasher of the present invention is very safe for use. The used high-temperature steam and/or water for washing the dishware is collected at the water-collecting hole 122 at the lower side of the washing cabinet 12 and sent via the water-feedinghole 112 into the steam generator 11 for recycling. The dishwasher of the present invention therefore meets the requirements of water saving and environmental protection.

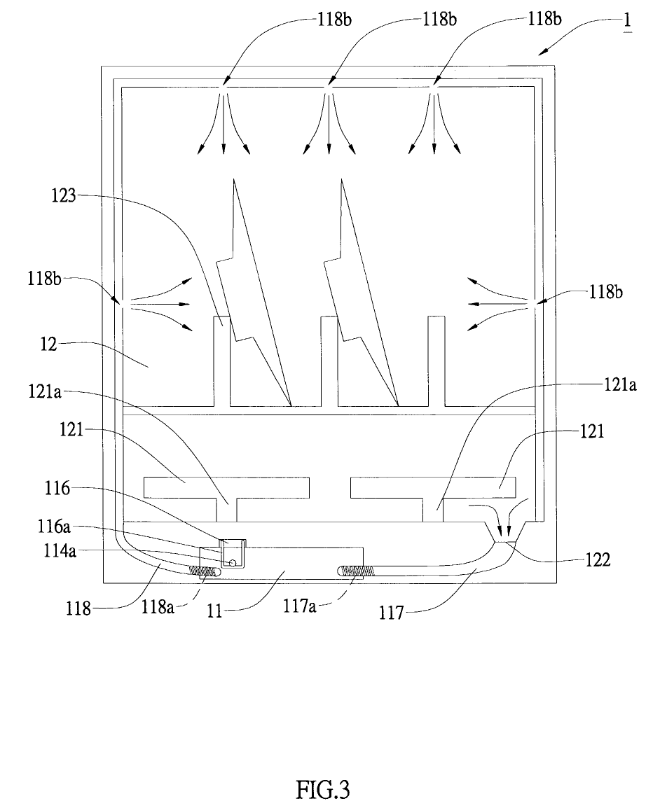

Please refer to FIG. 3. In addition to. the apertures 118d, the steam-feeding pipeline 118 may also be provided at predetermined points with spray holes 118b, so that the high-temperature steam is sprayed into and evenly distributed in the washing cabinet 12 via the spray holes 118b. The dishware to be cleaned is positioned on a rack 123 inside the washing cabinet 12. When the steam generator 11 starts operating, high-temperature steam is quickly produced and sent via the steam-feeding hole 113 to the steam-feeding pipeline 118 and into the washing cabinet 12 via the spray holes 118b, and sprayed onto the dishware in the cabinet 12 to quickly wash off any food residue attached thereto.

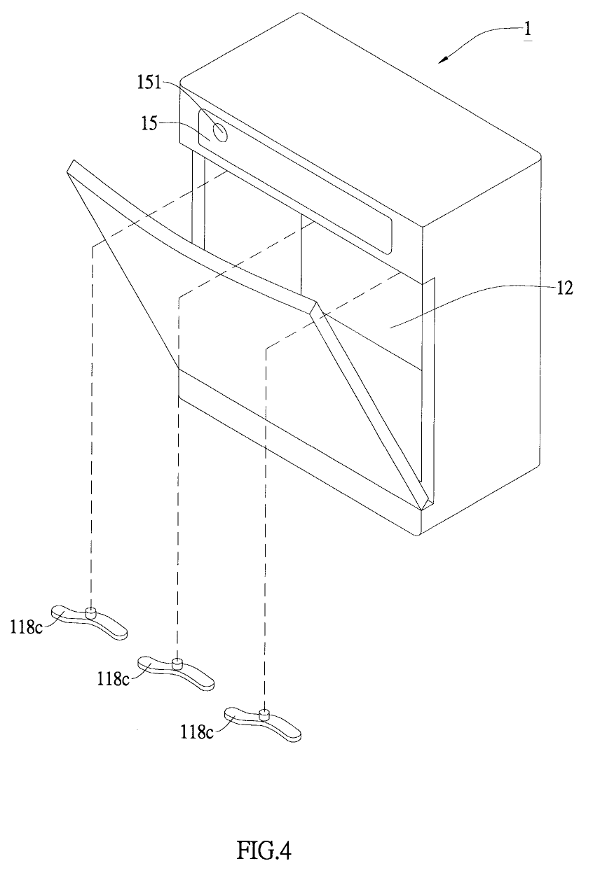

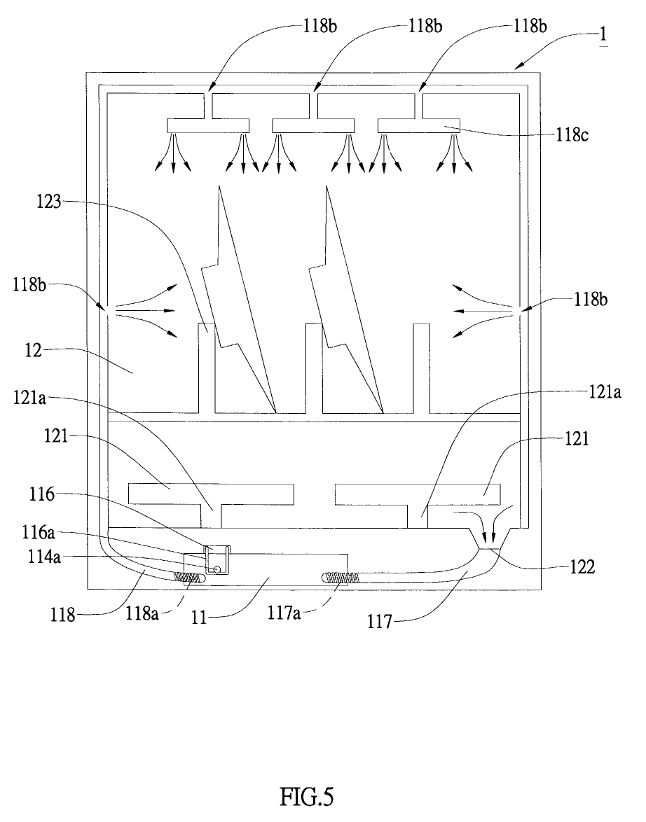

Please refer to FIGS. 4 and 5. Rotatable sprinklers 118c may be mounted in the washing cabinet 12 below the spray holes 118b of the steam-feeding pipeline 118 distributed over the inner surfaces of the washing cabinet 12, so as to effectively increase an area upon which the high-temperature steam could be sprayed to provided an enhanced cleaning efficiency.

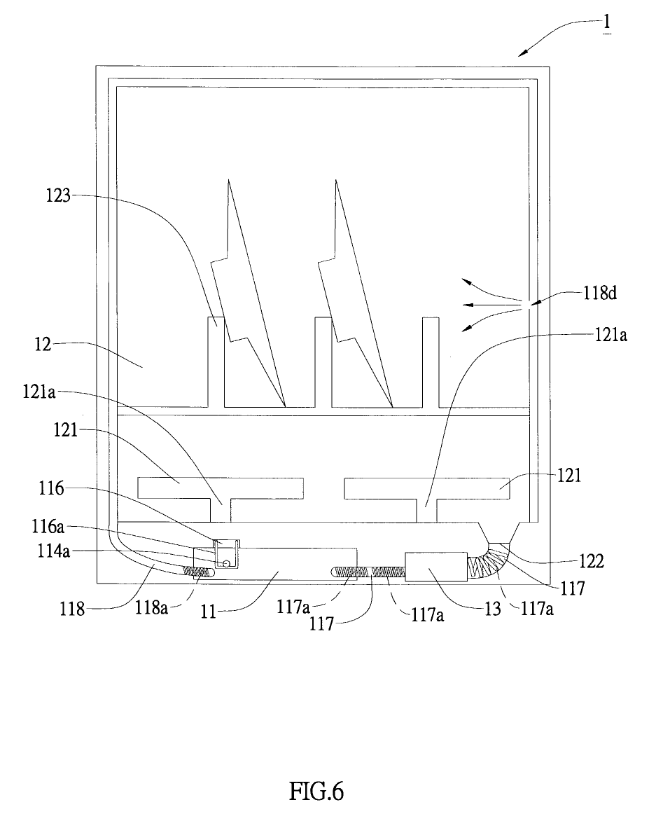

As can be seen from FIG. 6, a feed-water heater 13 may be connected to the water-feeding hose 117, so that water flown therethrough is pre-heated to a certain temperature before entering into the steam generator 11 via the water-feeding hole 112. This design enables quicker vaporization of water fed into the steam generator 11.

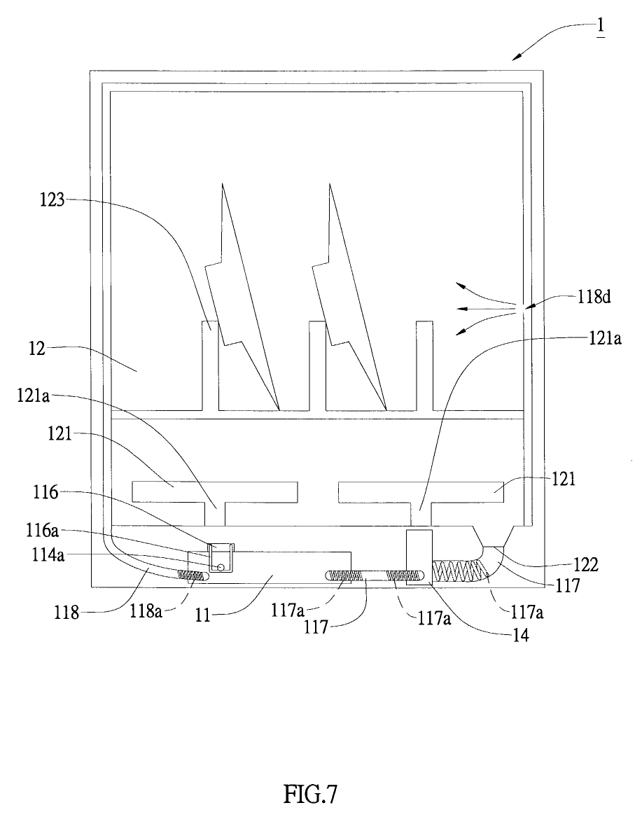

FIG. 7 shows a pump 14 is connected to the water-feeding hose 117 to pressurize water sent from the pump 14, so that water enters into the steam generator 11 at an increased flow rate to enable increased productivity of high-temperature steam and accordingly enhanced cleaning efficiency.

Metal springs 117a are provided at joints of the water-feeding hose 117 and the steam generator 11 and the heater 13 or the pump 14, and a metal spring 118a is provided at a joint of the steam-feeding pipeline 118 and the steam generator 11. The metal springs 117a, 118a serve to maintain the water-feeding hose 117 and the steam-feeding pipeline 118 in a desired shape without easily becoming deformed, bent, or broken and consequently leaked due to softening or aging under high temperature. Therefore, dangers in operation of the dishwasher of the present invention can be avoided and washing efficiency thereof can be maintained.

Please refer to FIG. 1 again. The dishwasher 1 according to the first embodiment of the present invention includes a wash control panel 15 provided at a front of the washing cabinet 12. A wash control button 151 is provided on the wash control panel 15 for setting wash procedures. For example, the dishwasher 1 may be set to first wash off residual food from the dishware with the flushing blades 121, and then soften hardened residues on the dishware with the high-temperature steam produced by the steam generator 11, and finally wash the dishware clean with the flushing blades 121. Alternatively, the dishwasher 1 may be set to first soften the hardened residues on the dishware with the high-temperature steam produced by the steam generator 11, and then flush the dishware with the flushing blades 121, and finally sterilize the dishware with the high-temperature steam produced by the steam generator 11. The wash control button 151 may also be used to set a desired wash time. In the case the dishware to be washed includes a large number of items or is considerably greasy, a longer wash time may be set. In brief, the dishwasher of the present invention is more practical for use because it can be set to most effective wash procedures to meet different user requirements.

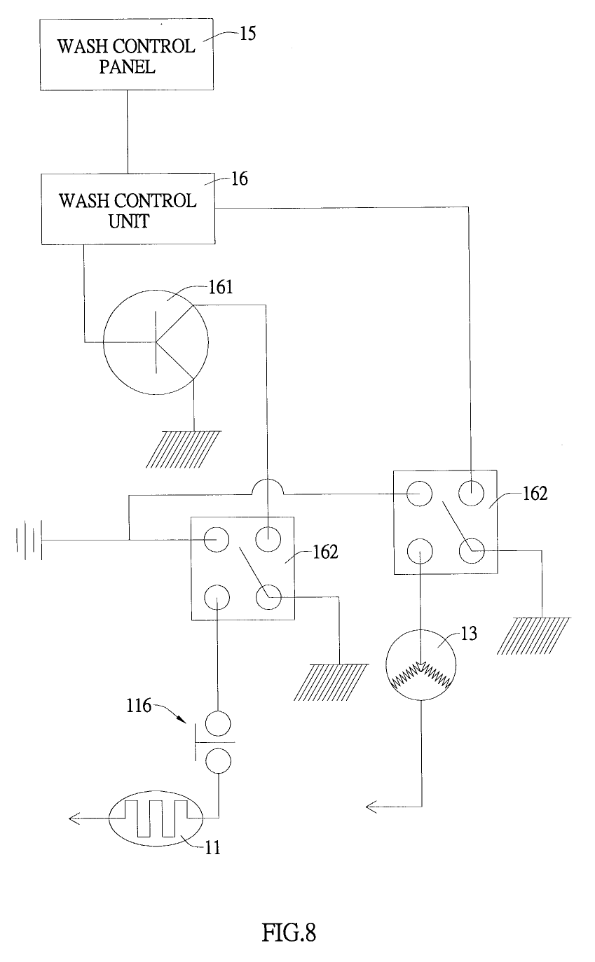

FIG. 8 shows a control circuit diagram for the dishwasher according to the first embodiment of the present invention. A wash control unit 16 serves as a circuit control center of the dishwasher 1, a wash control panel 15 serves as an operating area for wash procedure settings, and a driving element 161 serves to drive a relay 162. When a user completes setting of the wash procedures at the wash control panel 15 and the dishwasher 1 starts washing, the wash control unit 16 emits a signal to the driving element 161 for the same to actuate the relay 162, so that the temperature sensing and controlling unit 116 and the steam generator 11 are caused to operate. In the case a feed-water heater 13 is additionally provided to the dishwasher 1, the control circuit may be otherwise provided to control the overall wash procedures including pre-heating of water or steam fed to the steam generator 11.

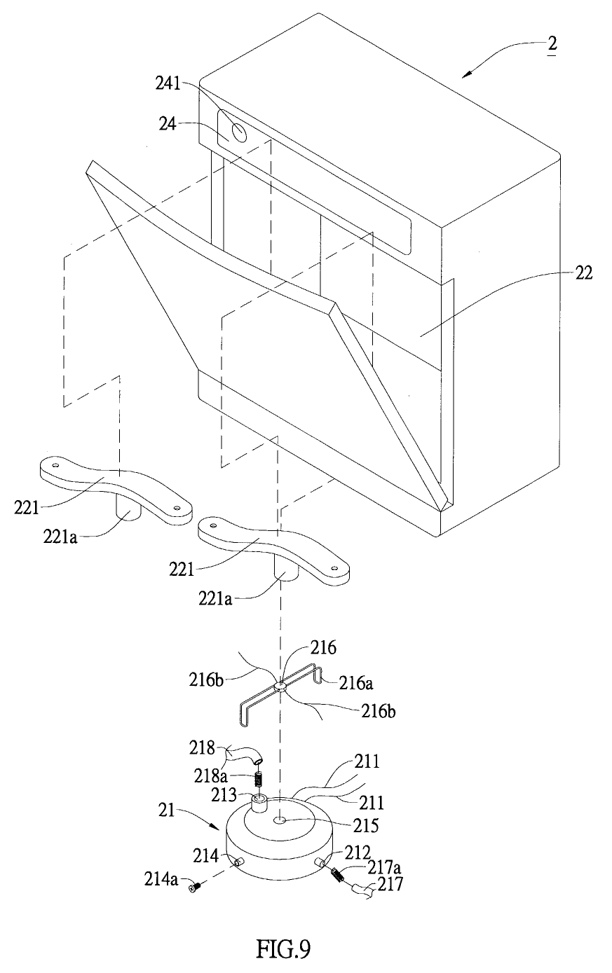

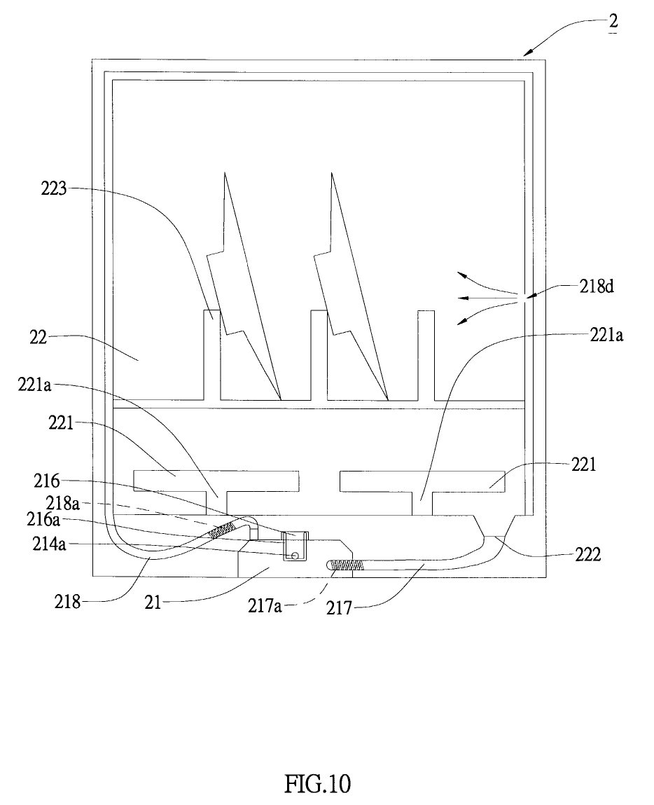

FIGS. 9 and 10 illustrates a dishwasher 2 according to a second embodiment of the present invention. As shown, the dishwasher 2 mainly includes a boiler 21 and a washing cabinet 22 into which dishware to be washed is positioned.

The boiler 21 has a power cord 211 connected to a lower side thereof, and is provided at two ends with a water-feeding hole 212 and a steam-feeding hole 213. Two threaded holes 214 are symmetrically provided at predetermined positions on an outer wall of the boiler 21, and a temperature-sensing hole 215 is provided at a predetermined position near an upper side of the boiler 21. The boiler 21 is used to boil water and thereby produce high-temperature steam for sending to the washing cabinet 22.

A temperature sensing and controlling unit 216 having a fixing bracket 216a extended from two opposite sides thereof and a power cord 216b connected thereto is mounted above the temperature-sensing hole 215 of the boiler 21 by locking two ends of the fixing bracket 216a to the threaded holes 214 with screw elements 214a, such that the temperature sensing and controlling unit 216 is firmly located on the boiler 21 for sensing a temperature and controlling an operation of the boiler 21.

Flushing blades 221 are rotatably connected at downward extended mounting stems 221a to an inner side of a bottom of the washing cabinet 22 to rotate while spray water upward to flush the dishware and remove any food residue therefrom. A water-collecting hole 222 is provided at a lower inner side of the washing cabinet 22. Washing is performed inside the washing cabinet 22 to clean all dishware positioned therein.

The boiler 21 is mounted below the washing cabinet 22. A water-feeding hose 217 is. connected to the water-feeding hole 212 to guide water into the boiler 21. A steam-feeding pipeline 218 is connected to the steam-feeding hole 213 to distribute over inner surfaces of the washing cabinet 22. When the boiler 21 starts operating, water fed thereinto is quickly heated and vaporized to produce high-temperature steam, which is sent via the steam-feeding hole 213 to the steam-feeding pipeline 218 and into the washing cabinet 22 via apertures 218d provided at predetermined points on the steam-feeding pipeline 218, and sprayed onto the dishware in the cabinet 22 to soften any hardened food residue attached thereto. Meanwhile, the flushing blades 221 rotate to spray water upward to wash off the softened food residues, so that an enhanced washing effect is provided. Moreover, the high-temperature steam provides a sterilization effect to thoroughly clean the dishware. When the boiler 21 is overheated due to insufficient water feeding, the temperature sensing and controlling unit 216 is actuated to cut off the boiler 21 to avoid the latter from being heated any further. Thus, the dishwasher of the present invention is very safe for use. The high-temperature steam and/or water used to wash the dishware is collected at the water-collecting hole 222 at the lower side of the washing cabinet 22 and sent via the water-feeding hole 212 into the boiler 21 for recycling. The dishwasher of the present invention therefore meets the requirements of water saving and environmental protection.

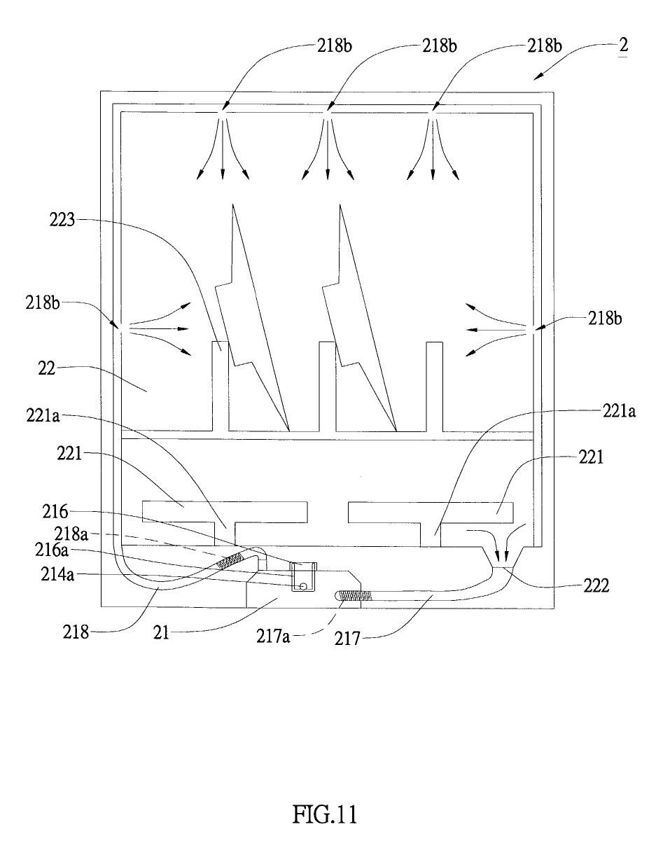

Please refer to FIG. 11. In addition to the apertures 218d, the steam-feeding pipeline 218 may also be provided at predetermined points with spray holes 218b, so that the high-temperature steam is sprayed into and evenly distributed in the washing cabinet 22 via the spray holes 218b. The dishware to be cleaned is positioned on a rack 223 inside the washing cabinet 22. When the boiler 21 starts operating, high-temperature steam is quickly produced and sent via the steam-feeding hole 213 to the steam-feeding pipeline 218 and into the washing cabinet 22 via the spray holes 218b, and sprayed onto the dishware in the cabinet 22 to quickly wash off any food residue attached thereto.

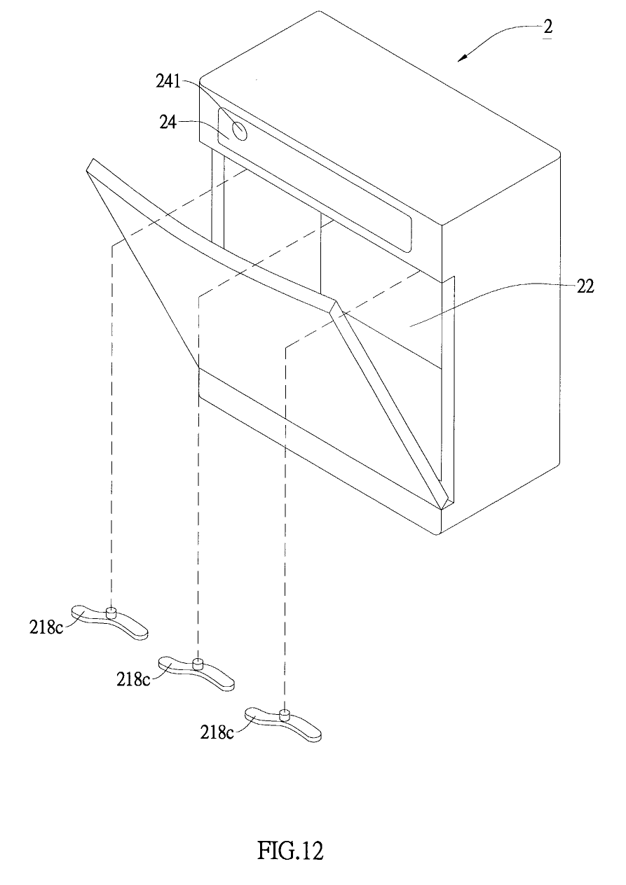

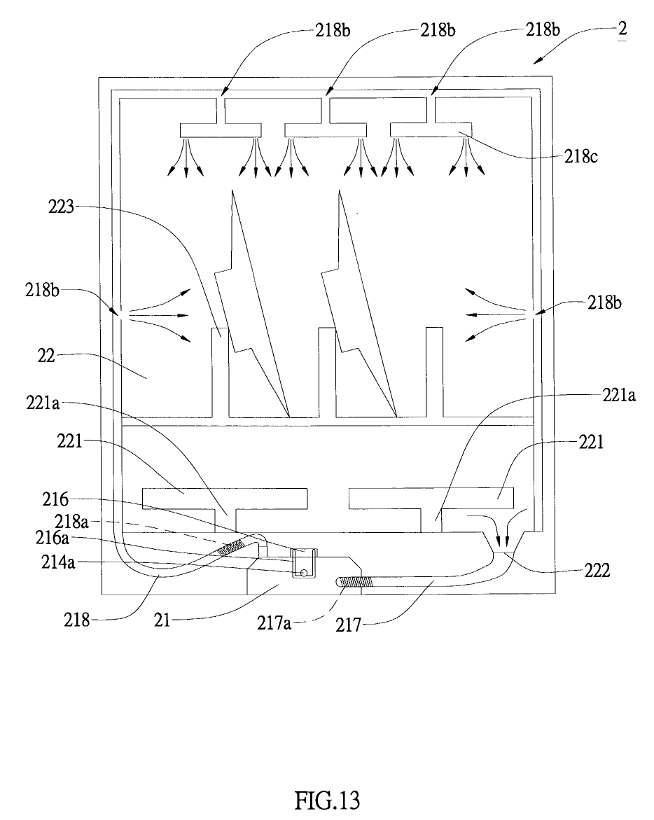

Please refer to FIGS. 12 and 13. Rotatable sprinklers 218c may be mounted in the washing cabinet 22 below the spray holes 218b of the steam-feeding pipeline 218 distributed over the inner surfaces of the washing cabinet 22, so as to effectively increase an area upon which the high-temperature steam could be sprayed to provide an enhanced cleaning efficiency.

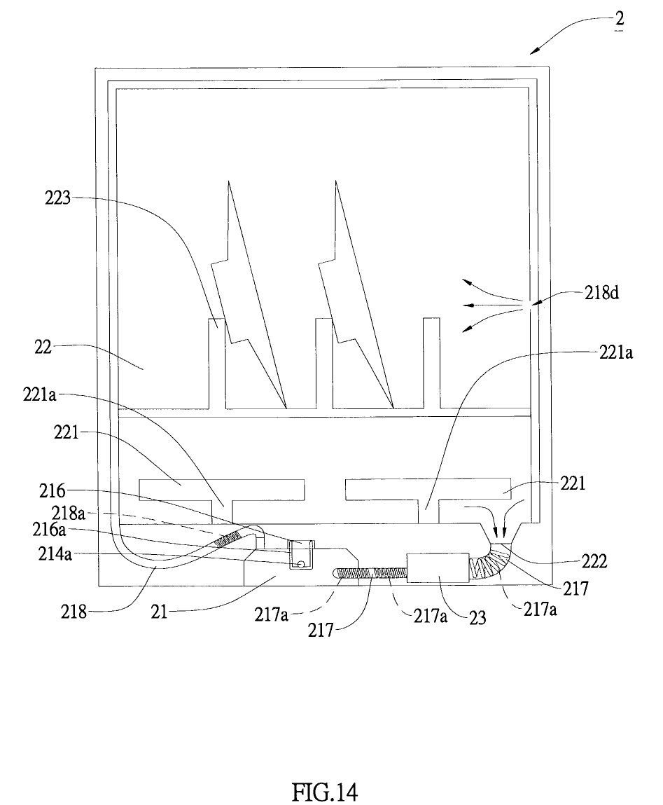

As can be seen from FIG. 14, a feed-water heater 23 may be connected to the water-feeding hose 217, so that water flown therethrough is pre-heated to a certain temperature before entering into the boiler 21 via the water-feeding hole 212. This design enables quicker vaporization of water fed into the boiler 21.

Metal springs 217a are provided at joints of the water-feeding hose 217 and the boiler 21 and the heater 23, and a metal spring 218a is provided at a joint of the steam-feeding pipeline 218 and the boiler 21. The metal springs 217a, 218a serve to maintain the water-feeding hose 217 and the steam-feeding pipeline 218 in a desired shape without easily becoming deformed, bent, or broken and consequently leaked due to softening or aging under high temperature. Therefore, dangers in operation of the dishwasher of the present invention can be avoided and washing efficiency thereof can be maintained.

Please refer to FIG. 9 again. The dishwasher 2 according to the second embodiment of the present invention includes a wash control panel 24 provided at a front of the washing cabinet 22. A wash control button 241 is provided on the wash control panel 24 for setting wash procedures. For example, the dishwasher 2 may be set to first wash off residual food from the dishware with the flushing blades 221, and then soften hardened residues on the dishware with the high-temperature steam produced by the boiler 21, and finally wash the dishware clean with the flushing blades 221. Alternatively, the dishwasher 2 may be set to first soften the hardened residues on the dishware with the high-temperature steam produced by the boiler 21, and then flush the dishware with the flushing blades 221, and finally sterilize the dishware with the high-temperature steam produced by the boiler 21. The wash control button 241 may also be used to set a desired wash time. In the case the dishware to be washed includes a large number of items or is considerably greasy, a longer wash time may be set. In brief, the dishwasher of the present invention is more practical for use because it can be set to most effective wash procedures to meet different user requirements.

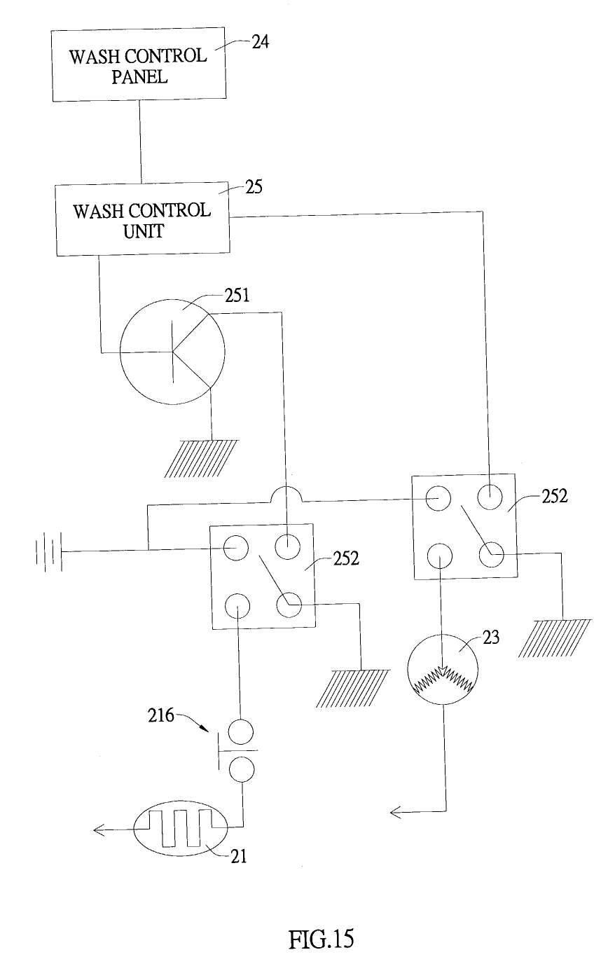

FIG. 15 shows a control circuit diagram for the dishwasher according to the second embodiment of the present invention. A wash control unit 25 serves as a circuit control center of the dishwasher 2, a wash control panel 24 serves as an operating area for wash procedure settings, and a driving element 251 serves to drive a relay 252. When a user completes setting of the wash procedures at the wash control panel 24 and the dishwasher 2 starts washing, the wash control unit 25 emits a signal to the driving element 251 for the same to actuate the relay 252, so that the temperature sensing and controlling unit 216 and the boiler 21 are caused to operate. In the case a feed-water heater 23 is additionally provided to the dishwasher 2, the control circuit may be otherwise provided to control the overall wash procedures including pre-heating of water or steam fed to the boiler 21.

The present invention has been described with some preferred embodiments thereof and it is understood that many changes and modifications in the described embodiments can be carried out without departing from the scope and the spirit of the invention as defined by the appended claims.

What is claimed is:

1. A dishwasher, comprising:
a steam generator for vaporizing water fed thereinto to produce high temperature steam being provided at two opposite ends with a water-feeding hole and a steam-feeding hole;
a washing cabinet for receiving and washing dishware to be washed;
a water-feeding hose connected at an end to said water-feeding hole on said steam generator; and
a steam-feeding pipeline connected at an end to said steam-feeding hole on said steam generator to distribute over inner surfaces of said washing cabinet;
whereby when water is guided by said water-feeding hose into said steam generator via said water-feeding hole, said water is quickly heated and vaporized to produce high-temperature steam, which is sent via said steam-feeding hole to said
steam-feeding pipeline distributed over inner surfaces of said washing cabinet and then into said washing cabinet to soften hardened food residues on said dishware received in said washing cabinet while cleaning and sterilizing said dishware.

2. The dishwasher as claimed in claim 1, wherein said steam-feeding pipeline is provided with spray holes, via which said high-temperature steam enters into said washing cabinet to evenly distribute therein while being sprayed onto said dishware to be washed.

3. The dishwasher as claimed in claim 2, wherein said spray holes on said steam-feeding pipeline have rotatable sprinklers mounted below said spray holes to increase an area upon which said high-temperature steam could be sprayed to clean said dishware to be washed.

4. The dishwasher as claimed in claim 1, wherein said steam generator is provided with a temperature sensing and controlling unit for sensing a temperature and controlling an operation of said steam generator; whereby when said steam generator is overheated due to an insufficient water feeding amount, said temperature sensing and controlling unit cuts off said steam generator to avoid the same from being heated any further.

5. The dishwasher as claimed in claim 1, wherein said water-feeding hose is connected at a predetermined position to a heater for pre-heating water to a certain temperature before the water is fed into said steam generator, so that the water could be more quickly vaporized in said steam generator to produce high-temperature steam.

6. The dishwasher as claimed in claim 5, wherein a metal spring is provided at a joint of said water-feeding hose and said heater to maintain said water-feeding hose in a desired shape without easily becoming deformed, bent, or broken due to softening or aging under high temperature.

7. The dishwasher as claimed in claim 1, wherein metal springs are provided at joints of said steam generator and said water-feeding hose and of said steam generator and said steam-feeding pipeline to maintain said water-feeding hose and said steam-feeding pipeline in desired shape without easily becoming deformed, bent, or broken due to softening or aging under high temperature.

8. The dishwasher as claimed in claim 1, wherein said water-feeding hose is connected at a predetermined position to a pump for increasing a water feeding rate to said steam generator and accordingly increasing a productivity of said high-temperature steam.

9. A dishwasher, comprising:
a boiler for converting water fed thereinto into high temperature steam being provided at two opposite ends with a water-feeding hole and a steam-feeding hole;
a washing cabinet for receiving and washing dishware to be washed;
a water-feeding hose connected at an end to said water-feeding hole on said boiler; and
a steam-feeding pipeline connected at an end to said steam-feedinghole on said boiler to distribute over inner surfaces of said washing cabinet;
whereby when water is guided by said water-feeding hose into said boiler via said water-feeding hole, said water is quickly heated and vaporized to produce high-temperature steam, which is sent via said steam-feeding hole to said steam-feeding pipeline distributed over inner surfaces of said washing cabinet and then into said washing cabinet to soften hardened food residues on said dishware received in said washing cabinet while cleaning and sterilizing said dishware.

10. The dishwasher as claimed in claim 9, wherein said steam-feeding pipeline is provided with spray holes, via which said high-temperature steam enters into said washing cabinet to evenly distribute therein while being sprayed onto said dishware to be washed.

11. The dishwasher as claimed in claim 10, wherein said spray holes on said steam-feeding pipeline have rotatable sprinklers mounted below said spray holes to increase an area upon which said high-temperature steam could be sprayed to clean said dishware to be washed.

12. The dishwasher as claimed in claim 9, wherein said boiler is provided with a temperature sensing and controlling unit for sensing a temperature and controlling an operation of said boiler; whereby when said boiler is overheated due to an insufficient water feeding amount, said temperature sensing and controlling unit cuts off said boiler to avoid the same from continuously increased temperature.

13. The dishwasher as claimed in claim 9, wherein said water-feeding hose is connected at a predetermined position to a heater for pre-heating water to a certain temperature before the water is fed into said boiler, so that the water could be more quickly vaporized in said boiler to produce high-temperature steam.

14. The dishwasher as claimed in claim 13, wherein a metal spring is provided at a joint of said water-feeding hose and said heater to maintain said water-feeding hose in a desired shape without easily becoming deformed, bent, or broken due to softening or aging under high temperature.

15. The dishwasher as claimed in claim 9, wherein metal springs are provided at joints of said boiler and said water-feeding hose and of said boiler and said steam-feeding pipeline to maintain said water-feeding hose and said steam-feeding pipeline in desired shape without easily becoming deformed, bent, or broken due to softening or aging under high temperature.
